(19) United States
(12) Patent Application Publication
(10) Pub. No.: US 2011/0121983 A1
(43) Pub. Date: May 26, 2011

(54) Heat Dissipation Device

(76) Inventor: Deng-Hsi CHEN, Liu Tu Industrial Park (TW)

(21) Appl. No.: 12/196,387

(22) Filed: Aug. 22, 2008

(30) Foreign Application Priority Data
Apr. 28, 2008 (TW) 097207258

(51) Int. Cl. G08B 21/18

(52) U.S. Cl. 340/635

(57) ABSTRACT

A heat dissipation device is assembled on an electronic device inside a computer case to decrease temperature generated when the electronic device is operating. The heat dissipation device includes primarily a cooling fan which is electrically connected with a rotation-speed-signal processing chip, and the rotation-speed-signal processing chip is electrically connected with a light emitting diode. In using the heat dissipation device, after a value of rotation speed of the cooling fan has been determined by the rotation-speed-signal processing chip which is electrically connected, a rotation speed signal is transmitted to the light emitting diode which issues a change of photochromism according to the rotation speed signal that has been received. By the change of photochromism from the light emitting diode, a current condition of the rotation speed of the cooling fan can be known.

### BACKGROUND OF THE INVENTION

a) Field of the Invention

The present invention relates to a heat dissipation device which is assembled on an electronic device, and more particularly to a heat dissipation device which is provided with light emitting diodes, with the light emitting diodes resulting in a change of corresponding photochromism according to rotation speed of a cooling fan in the heat dissipation device.

b) Description of the Prior Art

Rotation speed of an ordinary cooling fan is always kept at a constant; therefore, even temperature of an electronic device (such as a CPU (Central Processing Unit) or a display card) on which the cooling fan is assembled is too high, the rotation speed cannot be still increased to speed up heat dissipation. Among the merchant fans, there is a kind of cooling fan able to automatically sense temperature of the electronic device on which the cooling fan is assembled, so as to increase the rotation speed automatically for dissipating the heat. Its working principle is that when a set of thermistor (a resistor that is very sensitive to a change of temperature, with its resistance decreasing when the temperature rises, or that the resistance is inversely proportional to the temperature) which is assembled on an electronic device, has sensed that the temperature of the electronic device rises, the resistance of the thermistor will drop, and a voltage passing through the thermistor increase correspondingly to increase the rotation speed of the fan; or, a temperature value will be determined after a signal of resistance drop has been received by another temperature-signal processing chip, and then the signal after processing will be transmitted to the cooling fan, allowing the cooling fan to increase the rotation speed for dissipating the heat according to the signal received. Referring to FIG. 1, it shows a three-dimensional view of a conventional cooling fan, wherein a body of the cooling fan 10 is provided with a plurality of light emitting diodes 101 which will issue photochromism in a single color or a change of color to increase a pleasing effect of the cooling fan 10. Nevertheless, this kind of design can only increase the beauty of the cooling fan 10 and is not provided with any other function. Accordingly, if a condition of use for the electronic device or the heat dissipation device can be further transmitted by using the change of photochromism, then it should be able to improve an added value of that cooling fan.

### SUMMARY OF THE INVENTION

The present invention is to provide a heat dissipation device by which a current condition of rotation speed of a cooling fan can be determined from a change of photochromism issued by light emitting diodes assembled on the heat dissipation device.

Accordingly, a heat dissipation device of the present invention includes primarily a cooling fan, a rotation-speed-signal processing chip and more than one light emitting diode, wherein the cooling fan is electrically connected with the rotation-speed-signal processing chip, and the rotation-speed-signal processing chip is in turn electrically connected with the light emitting diodes. Upon using the heat dissipation device, corresponding to the rotation speed when the cooling fan is operating, a signal will be transmitted to the rotation-speed-signal processing chip. By determination with the rotation-speed-signal processing chip, it can be known that whether the current rotation speed of the cooling fan is high speed or low speed. After processing, the rotation-speed-signal processing chip will transmit a rotation speed signal to the light emitting diodes, and the light emitting diodes will use this rotation speed signal to issue a corresponding change of photochromism. For example, if the rotation-speed-signal processing chip has determined that the cooling fan is currently rotating in high speed, a rotation signal of high speed will be transmitted to the light emitting diodes that will issue the photochromism corresponding to the high speed, such as red light, to represent that the current temperature of the electronic device is higher. Therefore, the rotation speed of the cooling fan will be increased to speed up heat dissipation. By the photochromism issued from the light emitting diodes, the current conditions of the rotation speed of the cooling fan, and of the temperature of the electronic device, can be kept track of correctly.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a conventional cooling fan.

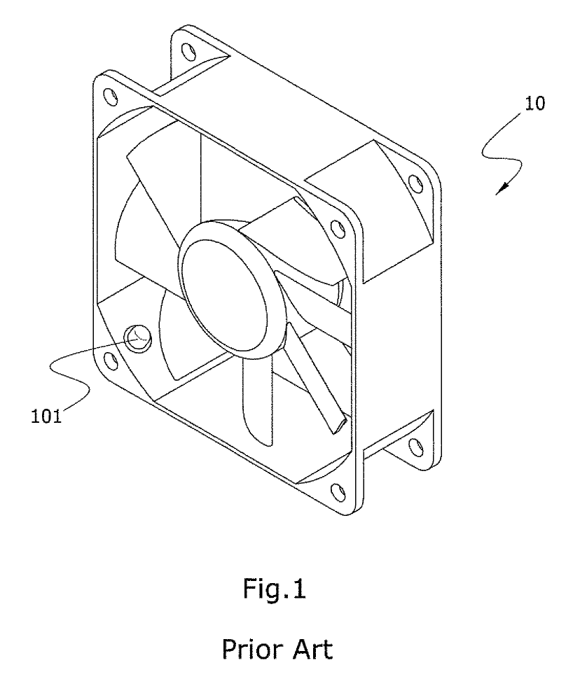

FIG. 2 shows a schematic view of components of the present invention.

FIG. 3 shows a first schematic view of units and an operation of the present invention upon being used.

FIG. 4 shows a second schematic view of units and an operation of the present invention upon being used.

FIG. 5 shows a third schematic view of units and an operation of the present invention upon being used.

### DETAILED DESCRIPTION OF THE PREFERRED EMBODIMENTS

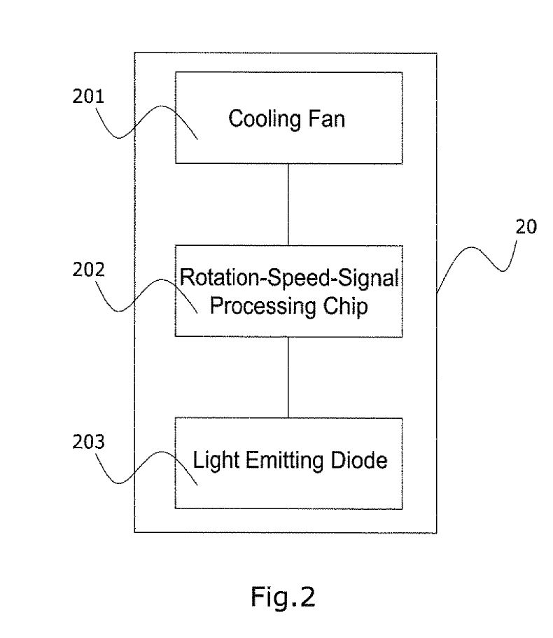

Referring to FIG. 2, it shows a schematic view of components of the present invention, wherein a heat dissipation device 20 comprises a cooling fan 201, a rotation-speed-signal processing chip 202 and more than one light emitting diode 203. The cooling fan 201 is electrically connected with the rotation-speed-signal processing chip 202, the rotation-speed-signal processing chip 202 is in turn electrically connected with the light emitting diodes 203, and the light emitting diodes 203 are physically assembled on a frame, a fan blade or a spindle of the cooling fan 201. When the cooling fan 201 starts to operate, a value of rotation speed will be produced by the cooling fan 201. This value of rotation speed will be processed by the rotation-speed-signal processing chip 202, and then a rotation speed signal will be transmitted to the light emitting diodes 203; whereas, after the rotation speed signal has been received by the light emitting diodes 203, photochromism corresponding to the rotation speed signal will be issued. For example, if the signal transmitted by the rotation speed signal represents high rotation speed, then red photochromism will be issued by the light emitting diodes 203 after receiving the rotation speed signal representing the high rotation speed; whereas, if the signal transmitted by the rotation speed signal represents low rotation speed, then blue photochromism will be issued by the light emitting diodes 203 after receiving the rotation speed signal. In addition, other different rotation speed signals will also enable the light emitting diodes 203 to issue various photochromism (such as yellow, orange or purple photochromism).

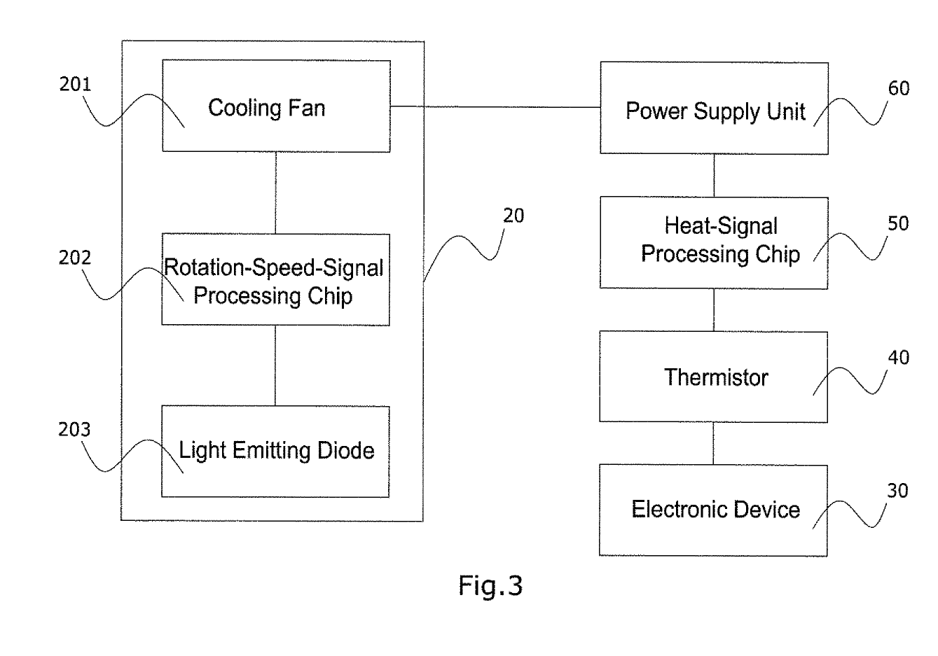

Referring to FIG. 3, it shows a first schematic view of units and an operation of the present invention upon being used, wherein an electronic device 30 (such as a CPU (Central Processing Unit) or a display card) is electrically connected with a thermistor 40, the thermistor 40 is electrically connected with a heat-signal processing chip 50, and the heat-signal processing chip 50 is in turn connected with a power supply unit 60. Finally, the power supply unit 60 is again connected with the cooling fan 201 in the heat dissipation device 20. When the electronic device 30 starts to operate, the connected thermistor 40 will sense temperature generated as the electronic device 30 is operating, and hence export an electronic signal (temperature signal) to the heat-signal processing chip 50. After this electronic signal has been determined and processed by the heat-signal processing chip 50, a temperature change of the electronic device 30 can be known. Next, the information after determination will be converted into another electronic signal which will then be transmitted to the power supply unit 60; whereas, the power supply unit 60 will adjust voltage exported to the cooling fan 201 in the heat dissipation device 20, according to the electronic signal that has been received. For example, when the electronic device 30 is currently at normal working temperature, then the voltage exported will be a positive value. When the working temperature rises gradually, the voltage exported can be also increased in response to the change of electronic signal. Therefore, the cooling fan 201 will operate according to the value of voltage, to increase the rotation speed, thereby achieving a requirement of rapidly dissipating the heat. On the other hand, after the cooling fan 201 has started to operate, a value of rotation speed will be produced by the cooling fan 201. This value of rotation speed will be processed by the rotation-speed-signal processing chip 202 that is electrically connected with the cooling fan 201, such that whether the value of rotation speed is a normal value, at high rotation speed or low rotation speed, can be determined. After determination with the rotation-speed-signal processing chip 202, the value of rotation speed will be converted into a rotation speed signal which is then transmitted to the light emitting diodes 203. After the rotation speed signal has been received by the light emitting diodes 203, photochromism corresponding to the rotation speed signal will be issued. For example, if the signal transmitted by the rotation speed signal is high rotation speed, then the red photochromism will be issued after the light emitting diodes 203 have received the rotation speed signal representing the high rotation speed; whereas, if the signal transmitted by the rotation speed signal is low rotation speed, then the blue photochromism will be issued after the light emitting diodes 203 have received the rotation speed signal. In addition, other different rotation speed signals will also enable the light emitting diodes 203 to issue various photochromism (e.g., yellow, orange or purple photochromism). Accordingly, by the photochromism issued from the light emitting diodes 203, a user can be aware of the current rotation speed of the cooling fan 201 right away, which is a same as that the electronic device 30 on which the cooling fan 201 is assembled is at higher temperature. Therefore, the user is able to inspect that whether the computer is having a problem in operating environment, software or hardware, to result in temperature rise of a computer element.

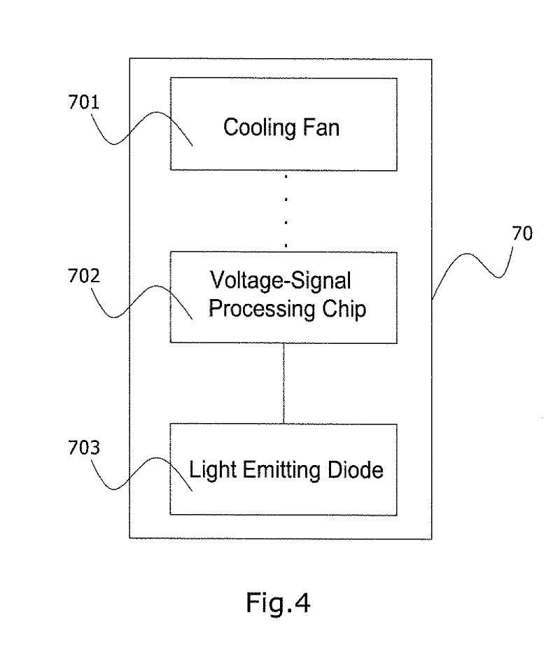

Referring to FIG. 4, it shows a second schematic view of units and an operation of the present invention upon being used, wherein a heat dissipation device 70 comprises a cooling fan 701, a voltage-signal processing chip 702 and a light emitting diode 703. The cooling fan 701 is electrically connected with the voltage-signal processing chip 702, and the voltage-signal processing chip 702 is in turn electrically connected with the light emitting diode 703. When the cooling fan 701 starts to operate, the cooling fan 701 will produce corresponding rotation speed, in response to the voltage received; whereas, this voltage value will be transmitted to the voltage-signal processing chip 702 from the cooling fan 701. By the processing with the voltage-signal processing chip 702, whether the voltage value is at high voltage or low voltage can be determined; and after the determination with the voltage-signal processing chip 702, the voltage value will be converted into a voltage signal which is then transmitted to the light emitting diode 703. In addition, after the voltage signal has been received by the light emitting diode 703, photochromism corresponding to the voltage signal will be issued. For example, if the signal transmitted by the voltage signal is high voltage, then the red photochromism will be issued after the voltage signal of high voltage has been received by the light emitting diode 703; whereas, if the signal transmitted is the voltage signal of low voltage, then the blue photochromism will be issued after the voltage signal has been received by the light emitting diode 703. In addition, other different voltage signals will also allow the light emitting diode 703 to issue various photochromism (e.g., yellow, orange or purple photochromism).

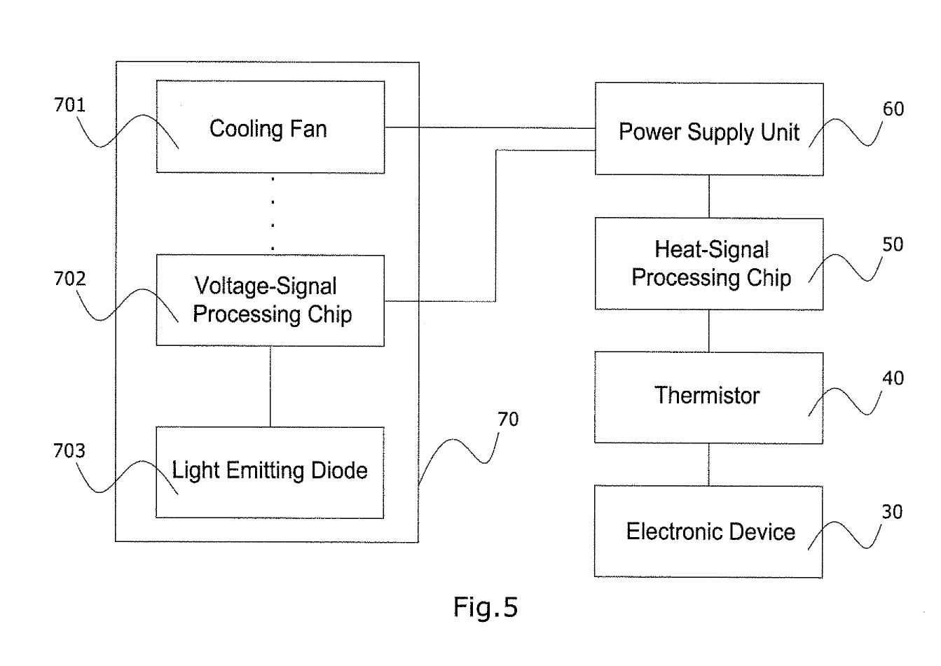

Referring to FIG. 5, it shows a third schematic view of units and an operation of the present invention upon being used, wherein a heat dissipation device 70 of the present invention comprises a cooling fan 701, a voltage-signal processing chip 702 and a light emitting diode 703, with the voltage-signal processing chip 702 being electrically connected with the light emitting diode 703. In using the heat dissipation device 70, the voltage-signal processing chip 702 is electrically connected with a power supply unit 60 which serves primarily as a power source to rotate the cooling fan 701. Furthermore, the power supply unit 60 is further electrically connected with a heat-signal processing chip 50 which is electrically connected with a thermistor 40. This thermistor 40 is then directly assembled (or affixed) at a heating part of an electronic device 30. When the electronic device 30 starts to operate, the connected thermistor 40 will sense temperature generated when the electronic device 30 is operating, and hence export an electronic signal (temperature signal) to the heat-signal processing chip 50. After this electronic signal has been determined and processed by the heat-signal processing chip 50, the current temperature of the electronic device 30 can be known. Next, the electronic signal that has been determined is transmitted to the power supply unit 60 which will export proper voltage to the cooling fan 701 in the heat dissipation device 70, according to the electronic signal that has been received and determined, so as to activate the cooling fan 701 to produce proper rotation speed. As the power supply unit 60 is electrically connected with the voltage-signal processing chip 702, when the power supply unit 60 is exporting the voltage, the voltage value will be exported to the voltage-signal processing chip 702 in terms of the electronic signal. By the processing with the voltage-signal processing chip 702, whether the voltage value is high voltage or low voltage can be determined. After the determination with the voltage-signal processing chip 702, the voltage value will be converted into another voltage signal which is transmitted to the light emitting diode 703; whereas, corresponding photochromism will be issued after the voltage signal has been received by the light emitting diode 703. For example, if the signal transmitted by the voltage signal is high voltage, then the red photochromism will be issued after the voltage signal of high voltage has been received by the light emitting diode 703; whereas, if the signal exported by the voltage signal is low voltage, then the blue photochromism will be issued after the voltage signal has been received by the light emitting diode 703. In addition, other different voltage signal will also enable the light emitting diode 703 to issue various photochromism (e.g., yellow, orange or purple photochromism). Therefore, the user can be aware of the current condition of the rotation speed of the cooling fan 701 by directly inspecting with eyes the photochromism issued by the light emitting diode 703, and can thus know the working temperature of the electronic device 30 indirectly. Accordingly, the user can further inspect that whether the computer is having a problem in operating environment, software or hardware to result in temperature rise of a computer element.

Accordingly, when the present invention is implemented, the value of rotation speed is transmitted by the cooling fan to the rotation-speed-signal processing chip to be processed as the rotation speed signal, and then the corresponding photochromism will be issued by the light emitting diode, after the rotation speed signal has been transmitted to the light emitting diode. Therefore, the object of providing the heat dissipation device by which the current condition of the rotation speed of the cooling fan can be determined from the photochromism issued by the light emitting diode is actually achieved.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A heat dissipation device, which is assembled in a computer to dissipate heat therefrom as needed, comprising a cooling fan which rotates when being connected with electricity; a rotation-speed-signal processing chip, which is electrically connected with the cooling fan to detect a value of rotation speed when the cooling fan is operating and to process that value of rotation speed as a rotation speed signal before exporting out the signal; and more than one light emitting diode which is electrically connected with the rotation-speed-signal processing chip, and produces a change of photochromism corresponding to the rotation speed that is exported from the rotation-speed-signal processing chip.

2. The heat dissipation device according to claim 1, wherein a body of the light emitting diode is assembled on a frame, a fan blade, a spindle or a combination of the three, of the cooling fan.

3. The heat dissipation device according to claim 1, wherein the cooling fan is electrically connected with a power supply unit.

4. The heat dissipation device according to claim 3, wherein the power supply unit is electrically connected with a heat-signal processing chip.

5. The heat dissipation device according to claim 4, wherein the heat-signal processing chip is electrically connected with a thermistor.

6. The heat dissipation device according to claim 5, wherein the thermistor is assembled at a heating part of an electronic device.

7. A heat dissipation device, which is assembled in a computer to dissipate heat therefrom as needed, after being connected with a power supply unit, comprising a cooling fan which rotates when being energized by the power supply unit; a voltage-signal processing chip, an end of which is electrically connected with the power supply unit, the other end of which is electrically connected with a light emitting diode, and which processes a voltage value when the power supply unit exports electricity as a voltage signal before transmitting that signal to the light emitting diode, allowing that light emitting diode to issue photochromism corresponding to the voltage signal.

8. The heat dissipation device according to claim 7, wherein a body of the light emitting diode is assembled on a frame, a fan blade, a spindle or a combination of the three, of the cooling fan.

9. The heat dissipation device according to claim 7, wherein the power supply unit is electrically connected with a heat-signal processing chip.

10. The heat dissipation device according to claim 9, wherein the heat-signal processing chip is electrically connected with a thermistor.

11. The heat dissipation device according to claim 10, wherein the thermistor is assembled at a heating part of an electronic device.
